(19) United States
(12) Patent Application Publication
(10) Pub. No.: US 2008/0201732 A1
(43) Pub. Date: Aug. 21, 2008

(54) Method and apparatus for improving a channel change rate in an opencable system

(76) Inventor: Se-Oh Kwon, Seoul (KR)

Correspondence Address: ROBERT E. BUSHNELL, 1522 K STREET NW, SUITE 300, WASHINGTON, DC, 20005-1202, US

(21) Appl. No.: 12/071,169

(22) Filed: Feb. 15, 2008

(30) Foreign Application Priority Data
Feb. 15, 2007 (KR) 10-2007-0016100

(51) Int. Cl. H04N 7/167

(52) U.S. Cl. 725/31

(57) ABSTRACT

A method and system for improving a channel change rate using a conditional access table/program map table (CAT/PMT) to be transmitted in an out-of-band (OOB) band. First main data including a channel ID of a scrambled channel and Conditional access table (CAT) information corresponding thereto and defining a version is transmitted from a main program of a conditional access system (CAS) headend. Second main data including the channel ID and Program map table (PMT) information corresponding thereto and defining a version is transmitted from a main program of a demux/remux device. Third main data generated by receiving and combining the first and second main data is included in service information (SI) and is transmitted in an Out-of-band (OOB) band. After extracting only the third main data from the transmitted Service information (SI) in response to a channel change event signal, encrypted broadcast content of each channel is released and provided to a user.

### CLAIM OF PRIORITY

This application makes reference to and claims all benefits accruing under 35 U.S.C. §119 from an application for METHOD AND APPARATUS FOR IMPROVING A CHANNEL CHANGE RATE IN AN OPENCABLE SYSTEM earlier filed in the Korean Intellectual Property Office on Feb. 15, 2007 and there duly assigned Serial No. 2007-0016100.

### BACKGROUND OF THE INVENTION

1. Field of the Invention

The present invention relates to a method and apparatus for improving a channel change time in an OPENCABLE system, and more particularly to a method and apparatus for improving a channel change rate in an OPENCABLE system in which a cable card (point of deployment (POD)) is used and out-of-band (OOB) (including legacy OOB and diversity site group (DSG)) is present.

2. Description of the Related Art

OPENCABLE is a set of specifications for both hardware and software to define a next-generation digital consumer device for cable television industry. OPENCABLE uses the society of Cable Telecommunications Engineers (SCTE) standards for transporting of video signals with interface requirements, and adds a requirement for a Java based software interpreter to support the OpenCable Application Platform (OCAP). OPENCABLE may include a decryption system to protect secure content by employing either CableCARDs or a proposed software-based Downloadable Conditional Access System (DCAS). The Cable Telecommunications Engineers (SCTE) Standards provides standards to the cable telecommunications industry. The standards cover a wide range of industry needs from coaxial RF connectors to transmission protocols for high-speed data access over cable.

For a channel change in an OPENCABLE system, a set-top box (STB) receives service information (SI) in an out-of-band (OOB) band and interprets the received information to acquire channel change information regarding a frequency, a modulation scheme, a video packet ID (PID), an audio Video packet ID (PID), and the like. That is, a channel change scenario is as follows:

1) Channel key event generation,

2) Acquisition of frequency and modulation scheme information by parsing the Service information (SI),

3) Attempt to tune to a corresponding frequency,

4) Acquisition of a conditional access table (CAT) and a program map table (PMT) received in a tuned broadcast band (INBAND),

5) Delivery of a CAPMT table to a cable card (POD) after processing the Conditional access table (CAT) and the Program map table (PMT) and generating the CAPMT table, and

6) Audio/video (AV) play start.

Service information (SI) including information required for a channel change is transmitted from an out-of-band (OOB) service information (SI) generator, and is transmitted on an Out-of-band (OOB) channel of an Out-of-band (OOB) band serving as a band out of a broadcast band (INBAND) to an OPENCABLE Set-top box (STB) through a cable mode termination system (CMTS) (or Intersect). Conditional access table (CAT) information to be descrambled with a broadcast (AV) signal in a cable card (POD) is generated in a conditional access system (CAS) headend, and is transmitted in the broadcast band (INBAND) to OPENCABLE Set-top box (STB) through a demux/remux device.

In particular, OPENCABLE Set-top box (STB) includes a plurality of conditional access table and program map table (CAT/PMT) receivers and an Service information (SI) parsing/channel database (DB) for storing and parsing the Service information (SI) received on the Out-of-band (OOB) channel, and transmits Conditional access table/program map table (CAT/PMT) information received by each CAT/PAT receiver to cable card (POD).

In the contemporary OPENCABLE system as described above, information required for the channel change is mostly included in the Service information (SI) received on the Out-of-band (OOB) channel (hereinafter, referred to as the Out-of-band (OOB) Service information (SI) ). Conditional access table/program map table (CAT/PMT) information to be descrambled by the Point of deployment (POD), however, should be received after changing a broadcast band (INBAND) channel.

That is, since the Conditional access table/program map table (CAT/PMT) information is periodically downloaded (in general, in a time period of about 0.5 second) without receiving the Conditional access table/program map table (CAT/PMT) information simultaneously upon channel tuning, there is a problem in that a Conditional access table/program map table (CAT/PMT) information reception is time-consuming.

### SUMMARY OF THE INVENTION

It is therefore one of the object of the present invention to provide an improved method and apparatus for improving the channel change time in an OPENCABLE system to solve the foregoing problems as stated above.

It is another object of the present invention to provide a method and apparatus that may improve a channel change rate in an OPENCABLE system by transmitting conditional access table/program map table (CAT/PMT) information of each channel received on a broadcast band (INBAND) channel by means of an out-of-band (OOB) channel of an Out-of-band (OOB) band and transmitting the Conditional access table/program map table (CAT/PMT) information to a cable card simultaneously upon channel tuning.

According to an aspect of the present invention, there is provided a method for improving a channel change rate in a channel change in an OPENCABLE system, including transmitting, by a conditional access system (CAS) headend, Conditional access table (CAT) information of a scrambled channel to a service information (SI) generator; transmitting, by a demux/remux device, Program map table (PMT) information of the channel to the Service information (SI) generator; transmitting, by the Service information (SI) generator, the Conditional access table (CAT) information and the Program map table (PMT) information, on generated Service information (SI), to a set-top box; transmitting, by the set-top box, the Conditional access table (CAT) information and the Program map table (PMT) information extracted from the Service information (SI) to a cable card while tuning a frequency of a corresponding channel when a channel key event is generated; and descrambling, by the cable card, a scrambled changed channel on a basis of the Conditional access table (CAT) information and the Program map table (PMT) information received from the set-top box.

The step of transmitting the Conditional access table (CAT) information to the Service information (SI) generator may include transmitting first main data defining values corresponding to the Conditional access table (CAT) information in fields of a table structure having a version field, a channel ID field, a Conditional access table (CAT) length field, and a Conditional access table (CAT) body field.

The step of transmitting the Conditional access table (CAT) information to the Service information (SI) generator may include defining an increased version value in the version field by increasing the version value when the Conditional access table (CAT) information is changed, and retransmitting the first main data defining values corresponding to the changed Conditional access table (CAT) information in the fields.

The step of transmitting the Program map table (PMT) information to the Service information (SI) generator may include transmitting second main data defining values corresponding to the Program map table (PMT) information in fields of a table structure having a version field, a channel ID field, a Program map table (PMT) length field, and a Program map table (PMT) body field.

The step of transmitting the Program map table (PMT) information to the Service information (SI) generator may include defining an increased version value in the version field by increasing the version value when the Program map table (PMT) information is changed, and retransmitting the second main data defining values corresponding to the changed Program map table (PMT) information in the fields.

The method may further include combining, by the Service information (SI) generator, the Conditional access table (CAT) information and the Program map table (PMT) information and generating third main data defining values corresponding to fields of a table structure having a version field of a scrambled channel, a channel ID field, a Conditional access table (CAT) length field, a Conditional access table (CAT) body field, a Program map table (PMT) length field, and a Program map table (PMT) body field.

The step of transmitting the Conditional access table (CAT) information and the Program map table (PMT) information, on the generated Service information (SI), to the set-top box may include transmitting the third main data including the Conditional access table (CAT) information and the Program map table (PMT) information in a private section table format.

The method may further include parsing, by the set-top box, the Service information (SI) when the channel key event is generated and acquiring frequency and modulation scheme information of a changed channel, the Conditional access table (CAT) information, and the Program map table (PMT) information.

The Conditional access table (CAT) information and the Program map table (PMT) information may be transmitted on an Out-of-band (OOB) channel.

According to another aspect of the present invention, there is provided an OPENCABLE system including a Conditional access system (CAS) headend for transmitting Conditional access table (CAT) information of a scrambled channel to an Service information (SI) generator; a demux/remux device for transmitting Program map table (PMT) information of the channel to the Service information (SI) generator; the Service information (SI) generator for transmitting the Conditional access table (CAT) information and the Program map table (PMT) information of the channel, on generated Service information (SI), to a set-top box; the set-top box for extracting the Conditional access table (CAT) information and the Program map table (PMT) information from the Service information (SI) received from the Service information (SI) generator when a channel key event is generated and transmitting the Conditional access table (CAT) information and the Program map table (PMT) information to a cable card while tuning a frequency of a changed channel; and the cable card for descrambling a scrambled channel on a basis of the Conditional access table (CAT) information and the Program map table (PMT) information received from the set-top box.

The Conditional access system (CAS) headend may include a Conditional access table (CAT) transmitter for transmitting first main data defining values corresponding to the Conditional access table (CAT) information in fields of a table structure having a version field, a channel ID field, a Conditional access table (CAT) length field, and a Conditional access table (CAT) body field.

The demux/remux device may include a Program map table (PMT) transmitter for transmitting second main data defining values corresponding to the Program map table (PMT) information in fields of a table structure having a version field, a channel ID field, a Program map table (PMT) length field, and a Program map table (PMT) body field.

The Service information (SI) generator may include a Conditional access table/program map table (CAT/PMT) collector for combining the Conditional access table (CAT) information and the Program map table (PMT) information and generating third main data defining values corresponding to fields of a table structure having a version field of a scrambled channel, a channel ID field, a Conditional access table (CAT) length field, a Conditional access table (CAT) body field, a Program map table (PMT) length field, and a Program map table (PMT) body field.

The Conditional access table/program map table (CAT/PMT) collector may include the third main data in the Service information (SI) in a private section table format and transmits the third main data in an Out-of-band (OOB) band.

The set-top box may include a channel database (DB) for storing and parsing the Service information (SI); and a Conditional access table/program map table (CAT/PMT) extractor for interworking with the channel DB and extracting the Conditional access table (CAT) information and the Program map table (PMT) information from the Service information (SI) to transmit the Conditional access table (CAT) information and the Program map table (PMT) information to the cable card.

The Conditional access system (CAS) headend, the demux/remux device, and the Service information (SI) generator may be connected in a server-client structure.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram illustrating a configuration of a contemporary OPENCABLE system;

FIG. 2 is a diagram illustrating a configuration of an OPENCABLE Set-top box (STB) of FIG. 1;

FIG. 3 is a diagram illustrating a configuration of an OPENCABLE system constructed as an exemplary embodiment of the present invention; and

FIG. 4 is a list illustrating an example of a private section table format constructed as an exemplary embodiment of the present invention.

### DETAILED DESCRIPTION OF THE EXEMPLARY EMBODIMENTS

Contemporary methods and apparatus will be firstly described. Exemplary embodiments of the present invention will be then described in detail herein below with reference to the accompanying drawings. In the drawings, the same or similar elements are denoted by the same reference numerals even though they are depicted in different drawings. Descriptions of well-known functions and constructions are omitted for clarity and conciseness.

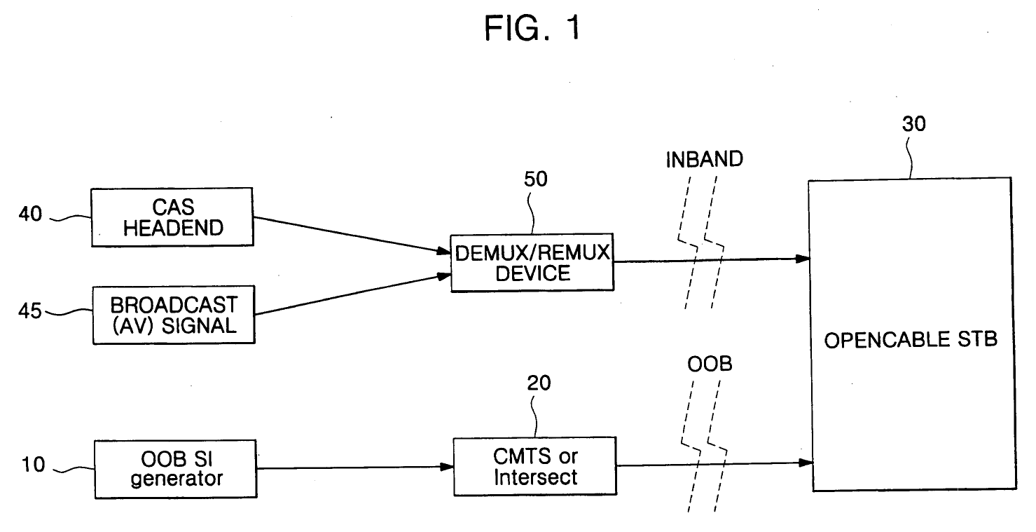

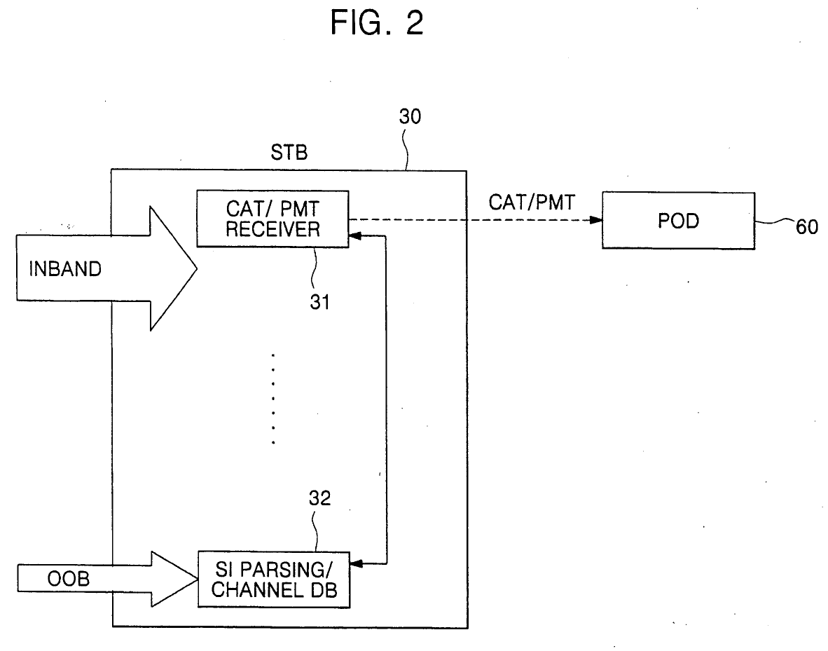

FIG. 1 illustrates a configuration of a contemporary OPENCABLE system, and FIG. 2 illustrates a configuration of an OPENCABLE Set-top box (STB) of FIG. 1.

As illustrated, Service information (SI) including information required for a channel change is transmitted from an out-of-band (OOB) service information (SI) generator 10, and is transmitted on an Out-of-band (OOB) channel of an Out-of-band (OOB) band serving as a band out of a broadcast band (INBAND) to an OPENCABLE Set-top box (STB) 30 through a cable mode termination system (CMTS) (or Intersect) 20. Conditional access table (CAT) information to be descrambled with a broadcast (AV) signal 45 in a cable card (POD) 60 is generated in a conditional access system (CAS) headend 40, and is transmitted in the broadcast band (INBAND) to OPENCABLE Set-top box (STB) 30 through a demux/remux device 50.

In particular, OPENCABLE Set-top box (STB) 30 includes a plurality of conditional access table and program map table (CAT/PMT) receivers 31 and an Service information (SI) parsing/channel database (DB) 32 for storing and parsing the Service information (SI) received on the Out-of-band (OOB) channel, and transmits Conditional access table/program map table (CAT/PMT) information received by each CAT/PAT receiver 31 to cable card (POD) 60.

In the contemporary OPENCABLE system as described above, information required for the channel change is mostly included in the Service information (SI) received on the Out-of-band (OOB) channel (hereinafter, referred to as the Out-of-band (OOB) Service information (SI) ). Conditional access table/program map table (CAT/PMT) information to be descrambled by the Point of deployment (POD), however, should be received after changing a broadcast band (INBAND) channel.

That is, since the Conditional access table/program map table (CAT/PMT) information is periodically downloaded (in general, in a time period of about 0.5 second) without receiving the Conditional access table/program map table (CAT/PMT) information simultaneously upon channel tuning, there is a problem in that a Conditional access table/program map table (CAT/PMT) information reception is time-consuming.

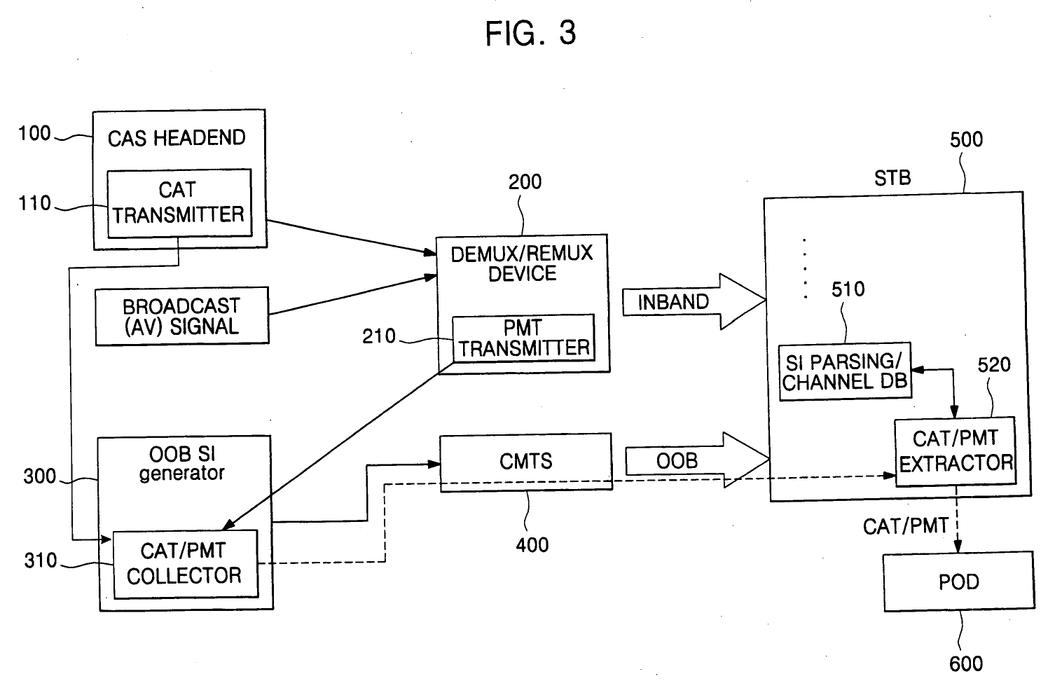

FIG. 3 illustrates a configuration of an OPENCABLE system constructed as an exemplary embodiment of the present invention.

As illustrated in FIG. 3, the OPENCABLE system of the present invention includes a Conditional access system (CAS) headend 100, a demux/remux device 200, an Out-of-band (OOB) Service information (SI) generator 300, a CMTS 400, an OPENCABLE Set-top box (STB) 500, and a cable card (POD) 600. Conditional access system (CAS) headend 100, demux/remux device 200, and Out-of-band (OOB) Service information (SI) generator 300 are connected to a network such as the Ethernet or the like.

Conditional access system (CAS) headend 100 is a device for encrypting broadcast content, and internally includes a Conditional access table (CAT) transmitter 110 to be performed with an application in Conditional access system (CAS) headend 100.

That is, Conditional access table (CAT) transmitter 110 operates with a network application to be performed in Conditional access system (CAS) headend 100, and Conditional access table (CAT) information to be descrambled in cable card (POD) 600 is transmitted to Out-of-band (OOB) Service information (SI) generator 300 and demux/remux device 200.

Demux/remux device 200 is a device for demuxing/remuxing and outputting the broadcast content encrypted in CAS headend 100, and internally includes a Program map table (PMT) transmitter 210 to be performed with an application in demux/remux device 200.

That is, Program map table (PMT) transmitter 210 operates with a network application to be performed in demux/remux device 200, and transmits Program map table (PMT) information (or a Program map table (PMT) value) including a table ID of a Conditional access table (CAT) to be transmitted from Conditional access table (CAT) transmitter 110 of Conditional access system (CAS) headend 100 to Out-of-band (OOB) Service information (SI) generator 300.

Out-of-band (OOB) Service information (SI) generator 300 generates and transmits Service information (SI) including third main data produced by combining the Conditional access table (CAT) information (hereinafter, referred to as ‘first main data’) and the Program map table (PMT) information (hereinafter, referred to as ‘second main data’), and internally includes a Conditional access table/program map table (CAT/PMT) collector 310 to be performed with an application in Out-of-band (OOB) Service information (SI) generator 300.

That is, Conditional access table/program map table (CAT/PMT) collector 310 operates with a network application to be performed in Out-of-band (OOB) Service information (SI) generator 300, generates the third main data by combining the first main data transmitted from Conditional access table (CAT) transmitter 110 and the second main data transmitted from Program map table (PMT) transmitter 210, and transmits the third main data in an Out-of-band (OOB) band to OPENCABLE Set-top box (STB) 500.

A server-client structure may be implemented in which Conditional access table/program map table (CAT/PMT) collector 310 acts as a client and Conditional access table (CAT) transmitter 210 and Program map table (PMT) transmitter 210 act as a server.

CMTS 400 is a network headend for providing OPENCABLE Set-top box (STB) 500 with the Service information (SI) including the third main data transmitted from Out-of-band (OOB) Service information (SI) generator 300.

OPENCABLE Set-top box (STB) 500 receives the Service information (SI) including the third main data in the Out-of-band (OOB) band through CMTS 400, and internally includes an Service information (SI) parsing/channel DB 510 and a Conditional access table/program map table (CAT/PMT) extractor 520 for interworking with Service information (SI) parsing/channel database (DB) 510, extracting the third main data, that is, the Conditional access table/program map table (CAT/PMT) information, from the Service information (SI), and transmitting the Conditional access table/program map table (CAT/PMT) information to cable card 600.

Cable card (POD) 600 receives the Conditional access table/program map table (CAT/PMT) information from Conditional access table/program map table (CAT/PMT) extractor 520 of OPENCABLE Set-top box (STB) 500 and provides a user with the Conditional access table/program map table (CAT/PMT) information after releasing encrypted content of a scrambled channel. That is, when a changed channel is a scrambled channel, cable card 600 performs a descrambling process on the basis of the Conditional access table/program map table (CAT/PMT) information.

Now, the functions of the applications operating Conditional access table (CAT) transmitter 110, PMT transmitter 210, and Conditional access table/program map table (CAT/PMT) collector 310 in the configuration of the OPENCABLE system of the present invention having the above-described structure will be described in details.

First, Conditional access table (CAT) transmitter 110 transmits the first main data defining a channel ID of a scrambled channel, a bundle of Conditional access table (CAT) information corresponding thereto, and a version form a Conditional access system (CAS) main program of Conditional access system (CAS) headend 100 to Conditional access table/program map table (CAT/PMT) collector 310 of Out-of-band (OOB) Service information (SI) generator 300. Whenever the Conditional access table (CAT) information is changed, a version count value is incremented and the first main data of a bundle of changed Conditional access table (CAT) information is newly transmitted.

The following Table 1 shows an example of the first main data to be transmitted from the Conditional access table (CAT) transmitter 110 to Conditional access table/program map table (CAT/PMT) collector 310.

TABLE 1
An example of the first main data

Version: Ox01
Channel id: Ox0001
CAT length: Ox32
CAT body: Ox001122334455 . . .
Channel id: Ox0002
. . .

As shown in Table 1, Conditional access table (CAT) transmitter 110 may provide Conditional access table/program map table (CAT/PMT) collector 310 with the first main data in which field values are defined in a table structure having a version field of a scrambled channel, a channel ID field, a Conditional access table (CAT) length field, and a Conditional access table (CAT) body field.

Program map table (PMT) transmitter 210 transmits the second main data defining a channel ID, a bundle of Program map table (PMT) information corresponding thereto, and a version form a demux main program to Conditional access table/program map table (CAT/PMT) collector 310 of Out-of-band (OOB) Service information (SI) generator 300. Whenever the Program map table (PMT) information is changed, a version count value is incremented and the second main data of a bundle of changed Program map table (PMT) information is newly transmitted.

The following Table 2 shows an example of the second main data to be transmitted from Program map table (PMT) transmitter 210 to Conditional access table/program map table (CAT/PMT) collector 310.

TABLE 2
Conditional access table/program map table

Version: Ox01
Channel id: Ox0001
PMT length: Ox32
PMT body: Ox001122334455 . . .
Channel id: Ox0002
. . .

As shown in Table 2, Program map table (PMT) transmitter 210 may provide Conditional access table/program map table (CAT/PMT) collector 310 with the second main data in which field values are defined in a table structure having a version field of a scrambled channel, a channel ID field, a Program map table (PMT) length field, and a Program map table (PMT) body field.

Conditional access table/program map table (CAT/PMT) collector 310 generates the third main data including the Conditional access table/program map table (CAT/PMT) information along with the existing Service information (SI) in an Service information (SI) generator main program by combining the first and second main data received from Conditional access table (CAT) transmitter 110 and Program map table (PMT) transmitter 210, transmits the third main data to OPENCABLE Set-top box (STB) 500, and transmits the third main data including the Service information (SI) and the Conditional access table/program map table (CAT/PMT) information based on a private section table format in the Out-of-band (OOB) band such that CAP/PMT extractor 520 can interpret the third main data.

The following Table 3 shows an example of the third main data to be transmitted from the Conditional access table/program map table (CAT/PMT) collector 310.

TABLE 3
an example of the third main data

Version: Ox01
Channel id: Ox0001
CAT length: Ox32
CAT body: Ox001122334455 . . .
PMT length: Ox32
PMT body: Ox001122334455 . . .
Channel id: Ox0002
. . .

As shown in Table 3, Conditional access table/program map table (CAT/PMT) collector 310 generates the third main data in which field values are defined in a table structure having a version field of a scrambled channel, a channel ID field, a Conditional access table (CAT) length field, a Conditional access table (CAT) body field, a Program map table (PMT) length field, and a Program map table (PMT) body field.

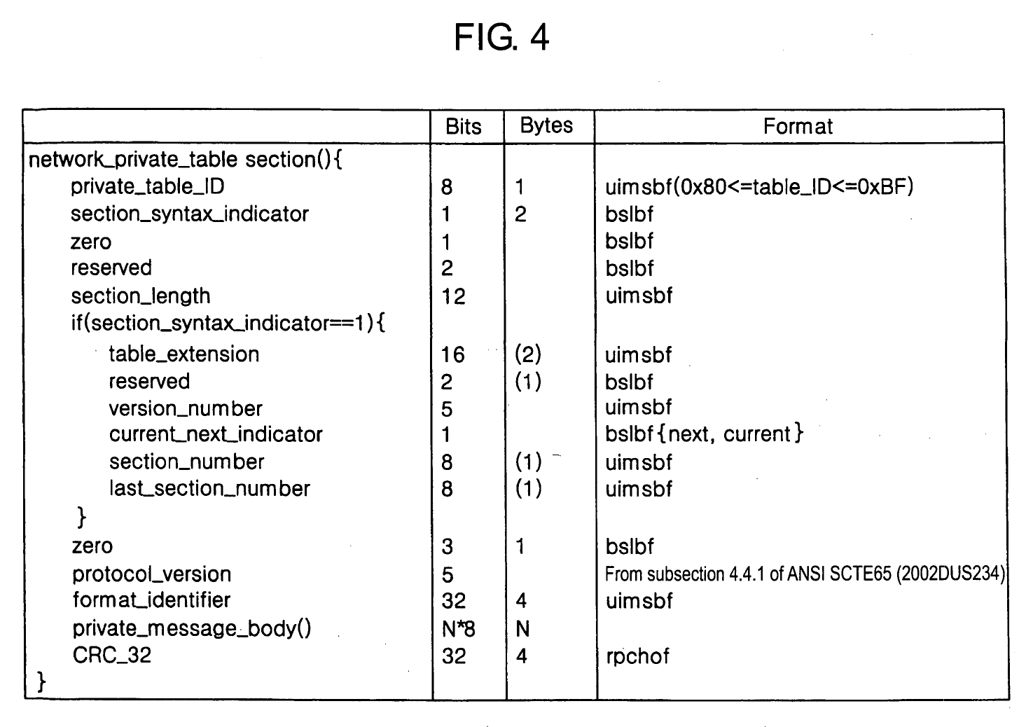

FIG. 4 illustrates an example of the private section table format constructed as an exemplary embodiment of the present invention. MPEG Service information (SI) has the format as illustrated in FIG. 4 in a private type and is identified by a unique private_table_ID. OPENCABLE Set-top box (STB) 500 can detect that details of received Service information (SI) are Conditional access table/program map table (CAT/PMT) information through a table ID.

In an MPEG Service information (SI), “private_table_ID” occupies eight bits (i.e., one byte), “section_syntax_indicator” occupies one bit, and the summarized length of “section_syntax_indicator”, “zero” and “reserved” has two bytes. When the value of “section_syntax_indicator” is equal to 1, the MPEG Service information (SI) includes a 16 bits of “table_externsion”, two bits of “reserved”, five bits of “version_number”, one bit of “current_next_indicator”, eight bit of “section_number” and 8 bits of “last_section_number”. When the value of “section_syntax_indicator” is not equal to one, above stated “table_externsion, “reserved”, “version_number”, “current_next_indicator”, “section_number”, and “last_section_number” do not exist in the MPEG Service information (SI). The MPEG Service information (SI) also includes three bits of “zero”, five bits of “protocol_version”, four bytes of “format_identifier”, a predetermined number of bytes of “private_message_body” and four bytes of “CRC”. Each above stated section has a corresponding format as shown in FIG. 4. Format “uimsbf” stands for “Unsigned Integer Most Significant Bit First”, format “bslbf” stands for “bit serial, leftmost bit first”, and format “rpchof” stands for “remainder polynomial coefficients, highest order first”. SI generator (CAT/PMT collector) transmits a private section table format which is defined in OpenCable specification “ANSI (American National Standards Institute) SCTE 65 (2002DVS234)” by including the third main data (CAT/PMT information). And, SI generator generates SI information including CAT/PMT information by referring to the defined private section table format. Therefore, Private_table_ID value refers to a newly defined value and private_messsage_body includes CAT/PMT information. The field of “private_messsage_body” has no exact format. As shown in sub-section 4.4.1 of OpenCable specification “ANSI (American National Standards Institute) SCTE 65 (2002DVS234)”, “protocol_version contemplates a 5-bit unsigned integer field which allows, in the future, any defined table type to carry parameters that may be structured fundamentally differently from those defined in the contemporary protocols. At present days, all defined table section types in this protocol are defined for protocol_version zero only. Nonzero values of protocol_version may only be processed by receivers designed to accommodate the later versions as they become standardized.”

And protocol_version and format_identifier value refer to the newly defined value. The value of “format_identifier” is not fixed and may vary by value of Private_table_ID.

When a private_table_ID value is “0x9E,” Service information (SI) including the Conditional access table/program map table (CAT/PMT) information has the format as shown in the following Table 4.

TABLE 4
Conditional access table/program map table

| | |
|---|---|
| Private_table_ID | Ox9E |
| Section_syntax_indicator | 0 when CAT/PMT length is less than 4096 |
| | bytes |
| Zero | 0 |
| Reserved | 0 |
| Section_length | Current table section length |
| Zero | 0 |
| Protocol version | 0 |
| Format_identifier | |
| Private_message_body | Third main data of CAT/PMT collector |
| CRC_32 | CRC |

Conditional access table/program map table (CAT/PMT) extractor 520 to be performed in OPENCABLE Set-top box (STB) 500 interworks with Service information (SI) parsing/channel DB 510 by extracting information in which a section table ID value corresponds to the above-defined private_table_ID value (for example, 0x9E).

That is, Conditional access table/program map table (CAT/PMT) extractor 520 of the present invention acts like the Conditional access table/program map table (CAT/PMT) receiver for collecting Conditional access table (CAT) and Program map table (PMT) information in a contemporary broadcast band (INBAND) and interworking with a channel DB.

When a channel change event is generated in a state in which the Conditional access table/program map table (CAT/PMT) information received in the Out-of-band (OOB) band interworks with the channel DB, a contemporary operation is performed in order of

“(1) channel key event generation,

(2) Service information (SI) parsing and frequency and modulation scheme information acquisition,

(3) an attempt to tune to a corresponding frequency,

(4) acquisition of Conditional access table (CAT) and Program map table (PMT) information transmitted from a tuned broadcast band (INBAND),

(5) delivery of a CAPMT acquired in the cable card, and

(6) Audio/video (AV) play start”

as described before.

An operation of the present invention, however, different from this contemporary operation is performed in order of

“(1) channel key event generation,

(2) Service information (SI) parsing, frequency and modulation scheme information acquisition, and Conditional access table (CAT) and Program map table (PMT) information acquisition from the Conditional access table/program map table (CAT/PMT) collector,

(3) an attempt of tuning to a corresponding frequency and delivery of the acquired Conditional access table (CAT) and Program map table (PMT) information to the cable card simultaneous therewith, and

(4) Audio/video (AV) play start”.

That is, a channel change time can be shortened since the contemporary steps of (4) and (5) are simultaneously performed in the step of (3) of the present invention. In other words, in the present invention, Out-of-band (OOB) Service information (SI) generator 300 transmits Service information (SI) including the third main data in the Out-of-band (OOB) channel to OPENCABLE Set-top box (STB) 500. When a channel is changed, OPENCABLE Set-top box (STB) 500 extracts the first main data (Conditional access table (CAT) information) and the second main data (Program map table (PMT) information) from the third main data included in the Service information (SI) and transmits the first and second main data to cable card 600. A changed channel may be descrambled without a delay time (of about 0.5 second) required to acquire the Conditional access table/program map table (CAT/PMT) information after cable card 600 makes a change of a channel of an existing broadcast band, such that a channel change rate may be improved.

According to the present invention, Conditional access table/program map table (CAT/PMT) information of each channel to be received through a broadcast band (INBAND) channel is received through an Out-of-band (OOB) channel, such that a time required to receive the Conditional access table/program map table (CAT/PMT) information may be shortened.

That is, an inband tuning process may be performed by receiving and using the Conditional access table/program map table (CAT/PMT) information on the Out-of-band (OOB) channel rather than the broadcast band (INBAND) channel and a process for receiving the Conditional access table/program map table (CAT/PMT) information in the broadcast band (INBAND) maybe omitted, such that a channel change time may be shortened.

While the present invention has been shown and described in connection with the preferred embodiments, it will be apparent to those skilled in the art that modifications and variations can be made without departing from the spirit and scope of the invention as defined by the appended claims.

What is claimed is:

1. A method for improving a channel change rate in a channel change in an OPENCABLE system, the method comprising steps of:
transmitting, with a conditional access system (CAS) headend, conditional access table (CAT) information of a scrambled channel to a service information (SI) generator during the channel change rate in a channel change in an OPENCABLE system;
transmitting, with a demux/remux device, program map table (PMT) information of the channel to the Service information (SI) generator;
transmitting, with the Service information (SI) generator, the Conditional access table (CAT) information and the Program map table (PMT) information, on generated Service information (SI), to a set-top box;
transmitting, with the set-top box, the Conditional access table (CAT) information and the Program map table (PMT) information extracted from the Service information (SI) to a cable card while tuning a frequency of a corresponding channel when a channel key event is generated; and
descrambling, with the cable card, a scrambled changed channel on a basis of the Conditional access table (CAT) information and the Program map table (PMT) information received from the set-top box.

2. The method according to claim 1, with the step of transmitting the Conditional access table (CAT) information to the Service information (SI) generator further comprising:
transmitting a first main data defining values corresponding to the Conditional access table (CAT) information in fields of a table structure having a version field, a channel ID field, a Conditional access table (CAT) length field, and a Conditional access table (CAT) body field.

3. The method according to claim 2, with the step of transmitting the Conditional access table (CAT) information to the Service information (SI) generator further comprising:
defining an increased version value in the version field by increasing the version value when the Conditional access table (CAT) information is changed, and retransmitting the first main data defining values corresponding to the changed Conditional access table (CAT) information in the fields.

4. The method according to claim 1, with the step of transmitting the Program map table (PMT) information to the Service information (SI) generator further comprising:
transmitting a second main data defining values corresponding to the Program map table (PMT) information in fields of a table structure having a version field, a channel ID field, a Program map table (PMT) length field, and a Program map table (PMT) body field.

5. The method according to claim 4, with the steps of transmitting the Program map table (PMT) information to the Service information (SI) generator further comprising:
defining an increased version value in the version field by increasing the version value when the Program map table (PMT) information is changed, and retransmitting the second main data defining values corresponding to the changed Program map table (PMT) information in the fields.

6. The method according to claim 1, further comprising:
combining, with the Service information (SI) generator, the Conditional access table (CAT) information and the Program map table (PMT) information and generating a third main data defining values corresponding to fields of a table structure having a version field of a scrambled channel, a channel ID field, a Conditional access table (CAT) length field, a Conditional access table (CAT) body field, a Program map table (PMT) length field, and a Program map table (PMT) body field.

7. The method according to claim 1, with the step of transmitting the Conditional access table (CAT) information and the Program map table (PMT) information, on generated Service information (SI), to the set-top box further comprising:
transmitting the third main data including the Conditional access table (CAT) information and the Program map table (PMT) information in a private section table format.

8. The method according to claim 1, further comprising:
parsing, with the set-top box, the Service information (SI) when the channel key event is generated and acquiring frequency and modulation scheme information of a changed channel, the Conditional access table (CAT) information, and the Program map table (PMT) information.

9. The method according to claim 1, in which the Conditional access table (CAT) information and the Program map table (PMT) information are transmitted on an out-of-band (OOB) channel.

10. An OPENCABLE system, comprising:
a Conditional access system (CAS) headend transmitting Conditional access table (CAT) information of a scrambled channel to an Service information (SI) generator;
a demux/remux device transmitting Program map table (PMT) information of the channel to the Service information (SI) generator;
the Service information (SI) generator transmitting the Conditional access table (CAT) information and the Program map table (PMT) information of the channel, on generated Service information (SI), to a set-top box;
the set-top box extracting the Conditional access table (CAT) information and the Program map table (PMT) information from the Service information (SI) received from the Service information (SI) generator when a channel key event is generated and transmitting the Conditional access table (CAT) information and the Program map table (PMT) information to a cable card while tuning a frequency of a changed channel; and
the cable card descrambling a scrambled channel on a basis of the Conditional access table (CAT) information and the Program map table (PMT) information received from the set-top box.

11. The OPENCABLE system according to claim 10, in which the Conditional access system (CAS) headend comprises:
a Conditional access table (CAT) transmitter transmitting first main data defining values corresponding to the Conditional access table (CAT) information in fields of a table structure having a version field, a channel ID field, a Conditional access table (CAT) length field, and a Conditional access table (CAT) body field.

12. The OPENCABLE system according to claim 10, in which the demux/remux device comprises:
a Program map table (PMT) transmitter transmitting second main data defining values corresponding to the Program map table (PMT) information in fields of a table structure having a version field, a channel ID field, a Program map table (PMT) length field, and a Program map table (PMT) body field.

13. The OPENCABLE system according to claim 10, further comprising a Program map table (PMT) transmitter transmitting the Program map table (PMT) information corresponding to a channel ID of the Conditional access table (CAT) information transmitted from the Conditional access system (CAS) headend.

14. The OPENCABLE system according to claim 10, in which the Service information (SI) generator comprises:
a Conditional access table/program map table (CAT/PMT) collector combining the Conditional access table (CAT) information and the Program map table (PMT) information and generating third main data defining values corresponding to fields of a table structure having a version field of a scrambled channel, a channel ID field, a Conditional access table (CAT) length field, a Conditional access table (CAT) body field, a Program map table (PMT) length field, and a Program map table (PMT) body field.

15. The OPENCABLE system according to claim 14, in which the Conditional access table/program map table (CAT/PMT) collector arranges the third main data in the Service information (SI) into a private section table format and transmits the third main data in an Out-of-band (OOB) band.

16. The OPENCABLE system according to claim 10, with the set-top box further comprising:
a channel database (DB) for storing and parsing the Service information (SI); and
a Conditional access table/program map table (CAT/PMT) extractor interworking with the channel DB and extracting the Conditional access table (CAT) information and the Program map table (PMT) information from the Service information (SI) to transmit the Conditional access table (CAT) information and the Program map table (PMT) information to the cable card.

17. The OPENCABLE system according to claim 10, with the Conditional access system (CAS) headend, the demux/remux device, and the Service information (SI) generator being connected in a server-client structure.

18. A method of a channel change in an OPENCABLE system, the method comprising steps of:
transmitting, with a first unit, a first main data defining values corresponding to a conditional access table(CAT) information to a third unit;
transmitting, with a second unit, a second main data defining values corresponding to a program map table (PMT) information to the third unit;
combining, by with third unit, the first main data and the second main data;
generating, by with third unit, a third main data defining values corresponding content contained in the first main data and the second main data;
transmitting, with the third unit, the third main data to a fourth unit; and
extracting, with the fourth unit, the third main data.

19. An OPENCABLE system, comprising:
a first unit transmitting conditional access table(CAT) information of a scrambled channel to an Service information (SI) generator;
a second unit transmitting program map table (PMT) information of the channel to the Service information (SI) generator;
a third unit combining a first main data defining values corresponding to the Conditional access table (CAT) information and the second main data and a second main data defining values corresponding to the Program map table (PMT) information;
said third unit generating a third main data defining values corresponding content contained in the first main data and the second main data; and
a fourth unit extracting the third main data.
